(19) United States
(12) Patent Application Publication
(10) Pub. No.: US 2016/0327467 A1
(43) Pub. Date: Nov. 10, 2016

(54) METHOD AND APPARATUS FOR DETECTING PARTICULATE MATTER

(71) Applicant: EMPIRE TECHNOLOGY DEVELOPMENT LLC, Wilmington, DE (US)

(72) Inventor: Vincenzo CASASANTA, III, Woodinville, WA (US)

(73) Assignee: EMPIRE TECHNOLOGY DEVELOPMENT LLC, Wilmington, DE (US)

(21) Appl. No.: 15/112,131

(22) PCT Filed: Jan. 15, 2014
(86) PCT No.: PCT/US14/11590

§ 371 Date: Jul. 15, 2016

(51) Int. Cl. G01N 15/02; G01N 21/53

(52) U.S. Cl. CPC G01N 15/0211; G01N 21/53; G01N 2015/0046

(57) ABSTRACT

Various methods and apparatuses for detecting particulate matter are described herein. An illustrative apparatus may include a diode laser positioned adjacent to a first end of an optical cavity having a length. The diode laser may be configured to direct a light beam in a direction towards a second end of the optical cavity. A plurality of detectors may be positioned along the length of the optical cavity in the direction of the light beam. Each detector may be configured to measure a portion of the light beam that is scattered substantially perpendicular to the direction. The apparatus may also include a computing device that is configured to receive data from each of the plurality of detectors and a data transmitting device that is configured to transmit the data to a portable electronic device. The data may correspond to an amount of measured scattered light.

### BACKGROUND

Air quality is a major concern in many parts of the world because of its potentially deleterious effects on individuals who breathe poor quality air. In many locations, measurement and reporting of air quality is used by various governing, regulatory, and institutional bodies to ensure public safety. However, other locations are unable to rely on a public-based analysis and reporting system. Accordingly, individuals in those locations may require a personalized measurement device.

It will therefore be desirable to develop a system for measuring and reporting air quality conditions that is sufficiently small and lightweight to be effortlessly transportable by an individual. In addition, affordable systems for measuring and reporting air quality conditions will also be desired.

### SUMMARY

In an embodiment, a particulate matter sensor may include an optical cavity having a length and a diode laser positioned at or near a first end of the optical cavity. The diode laser may be configured to direct a light beam in a direction towards a second end of the optical cavity. The particulate matter sensor may also include a plurality of detectors positioned along the length of the optical cavity. Each of the detectors may be configured to measure a portion of the light beam that is scattered substantially perpendicular to the direction of the light beam. The particulate matter sensor may also include a computing device that is configured to receive data from each of the plurality of detectors and a data transmitting device that is configured to transmit the data to a portable electronic device. The data may correspond to an amount of measured scattered light.

In an embodiment, an article of manufacture may include a particulate matter sensor. The particulate matter sensor may include an optical cavity having a length and a diode laser positioned at or near a first end of the optical cavity. The diode laser may be configured to direct a light beam in a direction towards a second end of the optical cavity. The particulate matter sensor may also include a plurality of detectors positioned along the length of the optical cavity. Each of the plurality of detectors may be configured to measure a portion of the light beam that is scattered substantially perpendicular to the direction of the light beam. The particulate matter sensor may also include a computing device that is configured to receive data from each of the plurality of detectors and a data transmitting device configured to transmit the data to a portable electronic device. The data may correspond to an amount of measured scattered light.

In an embodiment, a method of fabricating a particulate matter sensor may include providing an optical cavity having a length and positioning a diode laser at or near a first end of the optical cavity. The diode laser may be configured to direct a light beam in a direction towards a second end of the optical cavity. The method may further include positioning a plurality of detectors along the length of the optical cavity. Each of the plurality of detectors may be configured to measure a portion of the light beam that is scattered substantially perpendicular to the direction. The method may also include configuring a computing device to receive data from each of the plurality of detectors and configuring a data transmitting device to transmit the data to a portable electronic device. The data may correspond to an amount of measured scattered light.

In an embodiment, a method of detecting particulate matter in atmospheric samples may include directing a beam of light in a direction through an optical cavity on a particulate matter sensor and exposing the optical cavity to an atmosphere. The optical cavity may be configured to receive particles in the atmosphere that cause the beam of light to scatter. The method may further include detecting portions of the beam of light that have scattered substantially perpendicular to the direction, determining a particle size and a particle distribution from the portions of the beam of light, and transmitting data corresponding to the particle size and particle distribution to a portable electronic device.

In an embodiment, a system for detecting particulate matter in atmospheric samples may include a processor and a non-transitory, computer-readable storage medium in communication with the processor. The non-transitory, computer-readable storage medium may have one or more programming instructions that, when executed, cause the processor to direct a light emitting device to emit a beam of light in a direction through an optical cavity on a particulate matter sensor. The optical cavity may be configured to receive particles in an atmosphere that cause the beam of light to scatter. The non-transitory, computer-readable storage medium may further have one or more programming instructions that, when executed, cause the processor to receive, from one or more detectors, information regarding detected portions of the beam of light that have scattered substantially perpendicular to the direction, determine a particle size and a particle distribution of the portions of the beam of light, and transmit data corresponding to the particle size and particle distribution to a portable electronic device.

### BRIEF DESCRIPTION OF THE DRAWINGS

FIG. 1 depicts a perspective view of a particulate matter detection apparatus and an electronic device according to an embodiment.

FIG. 2 depicts a detailed perspective view of a particulate matter sensor according to an embodiment.

FIG. 3 depicts an illustrative schematic diagram of light movement through an inlet on the particulate matter sensor according to an embodiment.

FIG. 4 depicts a flow diagram of an illustrative method of fabricating a particulate matter sensor according to an embodiment.

FIG. 5 depicts a flow diagram of an illustrative method of detecting particulate matter according to an embodiment.

FIG. 6 depicts a block diagram of illustrative portions of a computing device according to an embodiment.

FIG. 7 depicts a plot graph an autocorrelation function showing decay according to an embodiment.

FIG. 8 depicts a plot graph of a diffusion of particles according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “optical bench” is an apparatus that is configured to receive and hold at least one light source and/or at least one optical device. An optical bench may be configured to observe and measure various optical phenomena. In some embodiments, the optical bench may be attachable to an electronic device, as described in greater detail herein.

An “electronic device” refers to a device that includes a processor and a tangible, computer-readable memory or storage device. The memory may contain programming instructions that, when executed by the processor, cause the device to perform one or more operations according to the programming instructions. Illustrative examples of an electronic device may include, but are not limited to, a personal computer, a supercomputer, a gaming system, a television, a portable electronic device, a medical device, a recording device, and/or the like.

A “portable electronic device” refers to an electronic device that is shaped and sized such that it can be transported by an individual without a vehicle for transporting. Accordingly, an individual may transport a portable electronic device in a pocket, in his/her hand, and/or the like. In some embodiments, the portable electronic device may be wearable by an individual. Illustrative examples of a portable electronic device may include, but are not limited to, a pager, a cellular phone, a feature phone, a smartphone, a personal digital assistant (PDA), a camera, a tablet computer, a phone-tablet hybrid device (“phablet”), a laptop computer, a netbook, an ultrabook, a global positioning satellite (GPS) navigation device, an in-dash automotive component, a media player, a watch, and/or the like.

A “computing device” is an electronic device, such as a computer, a processor, and/or any other component, device, or system that performs one or more operations according to one or more programming instructions.

“Particulate matter,” which is also known as “particle pollution” or PM, is a mixture of small particles and/or liquid droplets. Particle pollution generally contains any number of components such as, for example, acids (such as nitrates and sulfates), organic chemicals, metals, soil particles, and/or dust particles. Generally, particles are classified by size. For example, particles that are about 10 micrometers (μm) in average diameter or smaller are generally able to pass through the throat and nose and enter the lungs of an individual. Once inhaled, these particles can affect the cardiopulmonary system and cause adverse health effects. Inhalable coarse particles, such as those found near roadways and/or dusty areas, are about 2.5 μm to about 10 μm in average diameter. Fine particles, such as those found in smoke and/or haze, are about 2.5 μm in diameter or less. Such particles can be directly emitted from sources such as forest fires or can form when gases that are emitted from power plants, factories, automobiles, and/or the like react with gases found in the surrounding air.

“Dust” refers to fine particles that are suspended in the atmosphere. Sources of dust may include particles emitted directly into the air due to vegetation, burning of biomass, industrial activities, construction activities, wind, and/or the like. Dust is generally recognized as solid particulate matter having an average diameter of about 1 μm to about 75 μm. The dust may be formed directly or indirectly as a secondary particle that is formed by chemical processes in the atmosphere.

“Electromagnetic radiation,” as used herein, refers to a form of energy exhibiting wave-like behavior and having both electric and magnetic field components that oscillate in phase perpendicular to each other as well as perpendicular to the direction of energy propagation. Electromagnetic radiation is classified according to the frequency of its wave. In order of increasing frequency and decreasing wavelength, electromagnetic radiation includes radio waves, microwaves, infrared radiation, visible light, ultraviolet radiation, X-rays, and gamma rays. The term “electromagnetic radiation” may be used interchangeably herein with the term “light” and thus the respective terms have the same meaning.

The present disclosure relates generally to a portable particulate matter detection apparatus that can be easily transported by an individual without a need for a vehicle for transporting. More particularly, the present disclosure relates to a portable optical bench that is configured to emit electromagnetic radiation such as a beam of light, measure a portion of the electromagnetic radiation that is scattered by particulate matter, and transmit data obtained from the measuring to an electronic device, such as a portable electronic device.

Various environmental standards organizations generally recognize a plurality of outdoor air pollutants that require quantification to provide a reliable measurement of air quality. Illustrative outdoor air pollutants may include, but are not limited to carbon monoxide (CO), sulfur dioxide (SO₂), nitrogen dioxide (NO₂), lead (Pb), ozone (O₃), and particulate matter. These illustrative pollutants may collectively be recognized as criteria pollutants. In various geographical areas, standardized methods for measurement of these illustrative pollutants have been developed. Many of the standardized methods may require a large analytical apparatus that contains an intricate and detailed methodology for detection and reporting.

Particulate matter has generally been difficult to measure in the past because the small particles are difficult to detect without expensive, large, and sophisticated equipment. As previously described herein, particulate matter is generally recognized as any particles having an average diameter of about 2.5 μm to about 10 μm (PM10 particles), an average diameter of about 1 μm to about 2.5 μm (PM2.5 particles), and an average diameter of about 1 μm or less (PM1 particles). While a number of methods exist to measure PM10 particles and PM2.5 particles, such as, for example, gas phase collection, size based filtration, mass analysis, and/or laser scattering, these methods require devices and machinery that are large, expensive, and generally not portable by or affordable to an individual. Other solutions have used existing mobile device electronics, such as a camera or other imaging device, to measure particulate matter. However, such methods cannot provide an accurate measurement because of camera or imaging device limitations that prevent accurate viewing of small particulate matter, such as PM2.5 particles or PM1 particles.

FIG. 1 depicts a perspective view of a particulate matter detection apparatus 105 and an electronic device 110 according to an embodiment. The particulate matter detection apparatus 105 may generally be a device that can receive and measure electromagnetic radiation, such as an optical bench.

In various embodiments, the particulate matter detection apparatus 105 may be attachable to at least a portion of the electronic device 110. For example, the particulate matter detection apparatus 105 may be attachable to a back portion of the electronic device 110. The particulate matter detection apparatus 105 may be attachable by any means of permanent, semi-permanent, or removable fixture, including, for example, adhesives, hook and loop mechanisms, clips, fasteners, tongue and groove mechanisms, and/or the like.

The particulate matter detection apparatus 105 may generally be any shape and/or size. Accordingly, shape and/or size of the particulate matter detection apparatus 105 is not limited by this disclosure. In some embodiments, the particulate matter detection apparatus 105 may be shaped and/or sized such that it can be easily held or carried by a user. In some embodiments, the particulate matter detection apparatus 105 may be shaped and/or sized such that it can be placed in a user's pocket, purse, backpack, satchel and/or the like. In some embodiments, the particulate matter detection apparatus 105 may be shaped and/or sized such that it can be worn by the user. In some embodiments, the particulate matter detection apparatus 105 may have a shape and/or size that resembles at least some of the dimensions of the electronic device 110. Accordingly, in some embodiments, a user may be able to attach the particulate matter detection apparatus 105 to the electronic device 110 such that the particulate matter detection apparatus and the electronic device form a single unit. In some embodiments, the electronic device 110 may have the particulate matter detection apparatus 105 integrated therein. Thus, for example, a rear surface of the electronic device 110 may contain the particulate matter detection apparatus 105.

The particulate matter detection apparatus 105 may be configured to communicate with the electronic device 110. Communication may allow for transmission of data between the particulate matter detection apparatus 105 and the electronic device 110, as described in greater detail herein. The particulate matter detection apparatus 105 may be configured to communicate via a wireless or a physical connection to the electronic device 110. Thus, the particulate matter detection apparatus 105 and the electronic device 110 each may contain any number of components necessary to allow for communication between the devices. Illustrative wireless communication protocols may include, but are not limited to, 802.11, Bluetooth® (Bluetooth SIG, Inc., Kirkland, Wash.), near field communication (NFC), and/or the like.

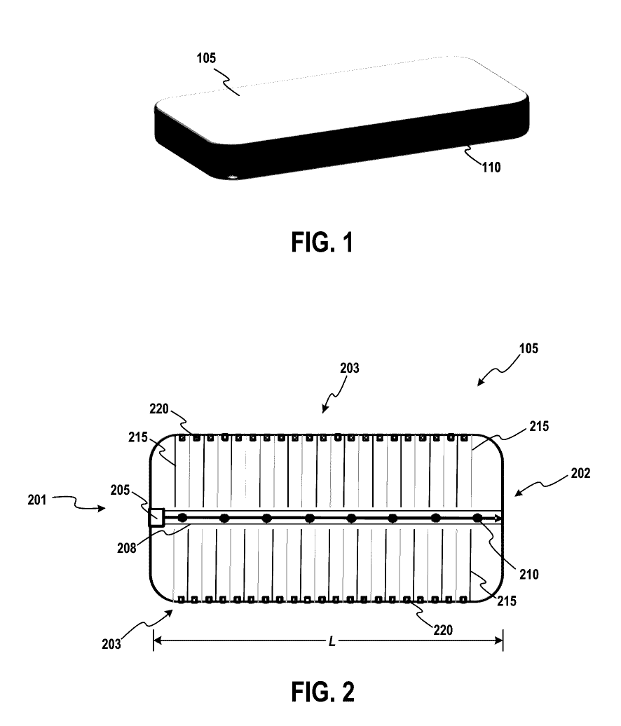

FIG. 2 depicts a detailed view of the particulate matter detection apparatus 105 according to an embodiment. The particulate matter detection apparatus 105 may generally have at least one length L. The length L may generally be any length that is suitable for propagating and detecting electromagnetic radiation as described herein. In some embodiments, the length L may correspond to a length of an electronic device to which the particulate matter detection apparatus 105 is configured to attach. The particulate matter detection apparatus 105 may generally include at least one light emitting device 205, an optical cavity 208 having at least one inlet 210, at least one optical baffle 215, and at least one detector 220. The particulate matter detection apparatus 105 may also include at least one computing device and at least one data transmitting device, as described in greater detail herein.

In various embodiments, the light emitting device 205 may be located at a first end 201 of the particulate matter detection apparatus 105. The light emitting device 205 may generally be configured to direct electromagnetic radiation through the optical cavity 208 along the length L towards a second end 202 of the particulate matter detection apparatus 105, as indicated by the arrow running along the length of the particulate matter detection apparatus. In some embodiments, the direction of the electromagnetic radiation emitted by the light emitting device 205 may pass through the one or more inlets 210 in the optical cavity 208, as described in greater detail herein. The light emitting device 205 is not limited by this disclosure, and may generally be any device configured to emit electromagnetic radiation. In some embodiments, the light emitting device 205 may be configured to emit particular wavelengths of electromagnetic radiation. In some embodiments, the light emitting device 205 may be configured to emit monochromatic light. In particular embodiments, the light emitting device 205 may be configured to emit coherent monochromatic light. In other embodiments, the light emitting device 205 may be configured to emit achromatic light or multichromatic light, such as dichromatic and trichromatic light. In some embodiments, the light emitting device 205 may be configured to emit pulses of light. In some embodiments, the light emitting device 205 may be configured to emit a focused beam of light. An illustrative light emitting device 205 may be a diode laser, which is an electrically pumped semiconductor laser in which an active medium is formed by a p-n junction of a semiconductor diode. Other illustrative light emitting devices include, but are not limited to, a light emitting diode (LED), a gas laser, a solid state laser, a fluorescent light source, an incandescent bulb, an arc lamp, a plasma lamp, an organic LED (OLED), and an electroluminescent light source.

In various embodiments, the optical cavity 208 may generally be a structure in which electromagnetic radiation propagates therethrough. The optical cavity 208 may be a sealed, a partially sealed, a sealable, or an open structure. In some embodiments, the optical cavity 208 may be sealed at every location except for the inlets 210 located in the optical cavity. In some embodiments, the optical cavity 208 may be configured to propagate an incident beam of electromagnetic radiation therethrough. In particular embodiments, the incident beam may scatter in the optical cavity 208.

Each inlet 210 may generally be a sampling cavity located in the optical cavity 208 that provides an interface between any environment in which the particulate detection apparatus 105 is located and the electromagnetic radiation emitted by the light emitting device 205 that passes through the inlet. Accordingly, each inlet 210 may be configured to receive ambient or atmospheric air surrounding the particulate detection apparatus 105. In some embodiments, each inlet 210 may be opened or closed, where an opened inlet allows ambient air to pass into the optical cavity 208 and a closed inlet prevents ambient air from passing into the optical cavity.

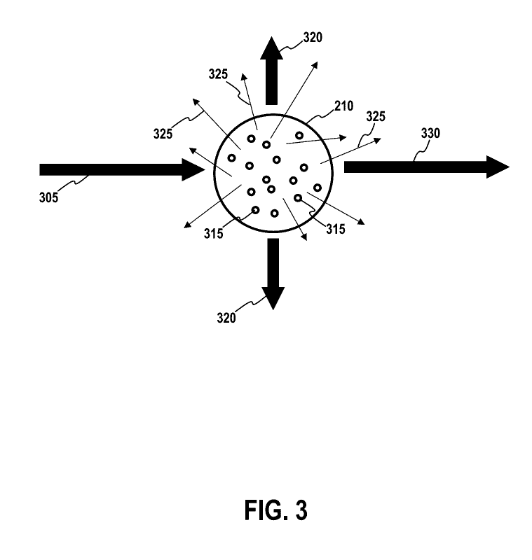

As shown in the detailed view of FIG. 3, various particles 315 present in the ambient air inlet 210 may cause an incident beam 305 passing through the inlet to scatter, as indicated by the arrows 320, 325, 330 moving away from the inlet. In some embodiments, the particles 315 may cause portions of the incident beam 305 to scatter in a substantially perpendicular direction, as indicated by the large perpendicular arrows 320. In some embodiments, the particles 315 may cause portions of the incident beam 305 to scatter in other directions, as indicated by the small arrows 325. In some embodiments, the particles 315 may not contact portions of the incident beam 305, thereby resulting in an unscattered transmitted beam 330.

Measurement of such dynamic light scattering (DLS) of the perpendicular scattered electromagnetic radiation 320 may be useful in determining a size distribution of the particles 315 that cause the scattering of the electromagnetic radiation. Within a volume of gas or liquid that contains the particles 315, the incident beam 305 of electromagnetic radiation is scattered by the particles that undergo random walk Brownian motion. The randomly moving particles 315 scatter the incident beam 305 into a cross-section that includes constructive and destructive interference between the particles that is not correlated. If a scattering intensity of these events is detected at a distance at a given angle, then the randomness of the scattering events will be observed as time varying fluctuations of an intensity (speckle) that is indicative of the diffusion of the particles 315. The time-dependent intensity I(t) of the scattering event measured over time becomes a convolution of scattering events that occur with a time interval τ. The intensity is expressed by an autocorrelation function G(τ) defined by Equation (1):

G(τ)= [symbol] I(t)×I(t+τ) [symbol] (1)

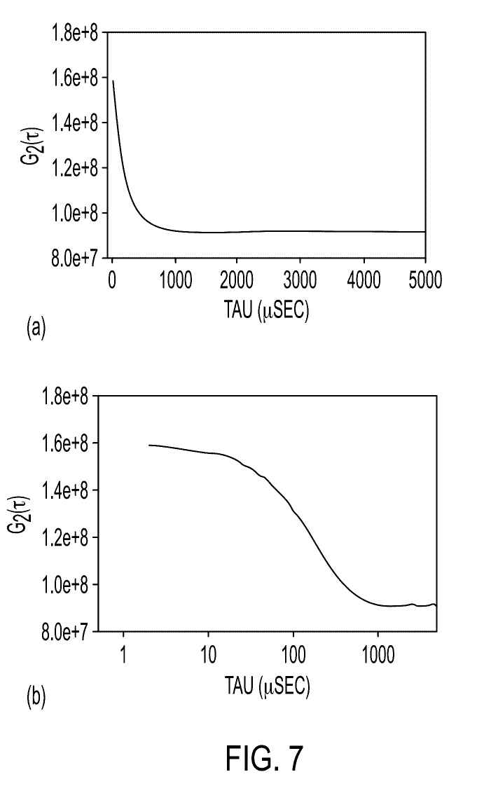

The autocorrelation function G(τ) describes the rate of change in scattering intensity by comparing the intensity at a time t to the intensity at a later time t+τ, providing a quantitative measurement of a flickering caused by the speckle. Because it is not possible to discover how each particle moves by monitoring the flickering caused by the speckle, the motion of the particles relative to each other is correlated. The autocorrelation function typically exhibits an exponential decay, as depicted by the linear (a) and logarithmic plots (b) shown in FIG. 7. From the DLS theory, the autocorrelation function from Equation (1) can further be expressed as Equation (2):

G(τ)=G(τ=∞)+G(τ=0)e^{-2Γτ} (2)

where Γ represents a decay that is observed as a full width at half maximum of the scattering spectrum and the baseline is determined by integrating an intensity over a long period.

The decay rate Γ may be related to a diffusion coefficient D of particles 305 in a medium as expressed by Equation (3):

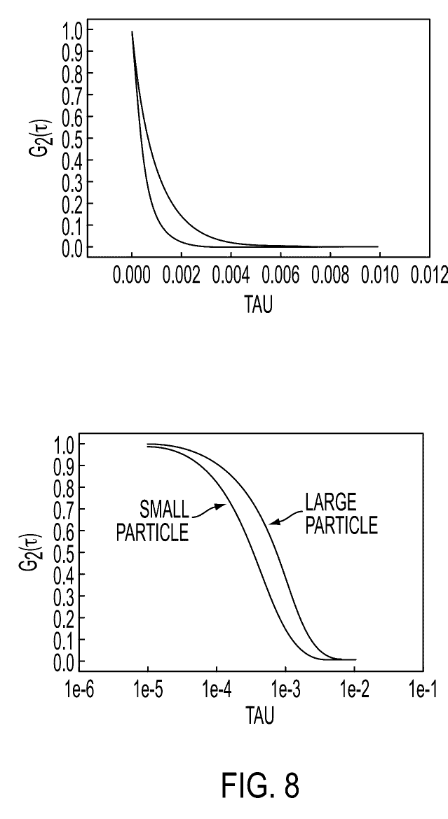

Γ=Dq² (3)

where q represents a magnitude of the scattering vector given by Equation (4):

$$q = \frac{4 π n}{λ} sin \frac{θ}{2} \qquad ( 4 )$$

where λ is the wavelength of the scattered light, n is the index of refraction of the medium (nₐᵢᵣ=1), and θ is the scattering angle (π/2 herein). With an assumption that the particles are spherical and non-interacting, a mean radius is obtained from the Stokes-Einstein equation (Equation (5)):

$$R = \frac{{k}_{B} T}{6 πη ( T ) D} \qquad ( 5 )$$

where k_{B} is the Boltzmann constant, T is the temperature, and η is the shear viscosity of the medium. For air, the viscosity is dependent on temperature. Thus, as is shown in the equations and the plots depicted in FIG. 8, large particles diffuse slower than small particles, and the correlation function decays at a slower rate. In this regard, a temperature measurement device may be integrated with the particulate detection apparatus 105 (FIG. 2) to make an accurate viscosity estimate for the calculation.

Information about the light-scattering spectrum can be obtained from the autocorrelation function G(τ) of the light-scattering intensity. For example, spherical, mono-disperse, non-interacting particles may exhibit a decay time of the correlation function that is inversely proportional to the line width of the spectrum. Thus, a diffusion coefficient and particle size or viscosity can be determined by fitting the measured correlation function to a single exponential function. The computing device portion of the particulate matter detection apparatus 105 (FIG. 2) may be configured to calculate such a particle size distribution by using data from the information gathered by the detector 220 and transmitted to the computing device. The data obtained by the computing device may correspond to a portion of scattered electromagnetic radiation that is measured by each detector 220 (FIG. 2).

Referring back to FIG. 2, a detector 220 may generally be any device configured to detect electromagnetic radiation. Particularly, a detector 220 may be configured to measure one or more of a size and/or distribution of particles that caused scattering of the electromagnetic radiation, as described in greater detail herein. An illustrative detector may include, but is not limited to, a photomultiplier tube (PMT), a photodiode, and a charge coupled detector (CCD). The PMT may be, for example, any silicon single photon sensitive device built from an avalanche photodiode (APD) array on a silicon substrate, such as a silicon avalanche photomultiplier.

Detectors 220 may be located along the length L of the particulate matter detection apparatus 105. In some embodiments, a detector 220 may be located adjacent to at least one edge 203 of the particulate detection apparatus 105 that is substantially parallel to the direction of the light beam propagated through the optical cavity 208. In some embodiments, each detector 220 may be located such that it can receive a portion of the electromagnetic radiation that is scattered substantially perpendicular to the direction of the incident beam 305 (FIG. 3), as described in greater detail herein. In some embodiments, each detector 220 may be connected to the computing device of the particulate matter detection apparatus 105 such that signals and/or data can be transmitted between each detector and the computing device.

Each detector 220 may include an aperture (not shown) therein. The aperture may be configured to only allow electromagnetic radiation that is scattered substantially perpendicular to the incident beam 305 (FIG. 3). Such a configuration may be achieved by a particular placement of the aperture in or on the detector 220. For example, the aperture may face the optical cavity 208 and/or an optical baffle 215.

To further ensure that a detector 220 receives only electromagnetic radiation that is scattered substantially perpendicular to the incident beam 305 (FIG. 3), the particulate matter detection apparatus 105 may employ at least one optical baffle 215. Optical baffles 215 are not limited by this disclosure, and may generally include any device that is configured to propagate electromagnetic radiation. An optical baffle 215 may generally extend from the optical cavity 208 to at least one of the detectors 220. In some embodiments, an optical baffle 215 may extend from an ambient air inlet 210 to at least one of the detectors 220. In some embodiments, an optical baffle 215 may extend from the optical cavity 208 and/or an ambient air inlet 210 in a direction that is substantially perpendicular to the optical cavity.

The data transmitting device (not shown) may be configured to transmit and/or receive data to and from an electronic device 110 (FIG. 1). As previously described herein, the data transmitting device may be configured to transmit and/or receive data via a physical and/or a wireless signal. Accordingly, the data transmitting device may be a wireless radio, a hub, a port, and/or the like. In some embodiments, the data transmitting device may be in communication with the computing device such that the data transmitting device can transmit and/or receive data and information to/from the computing device.

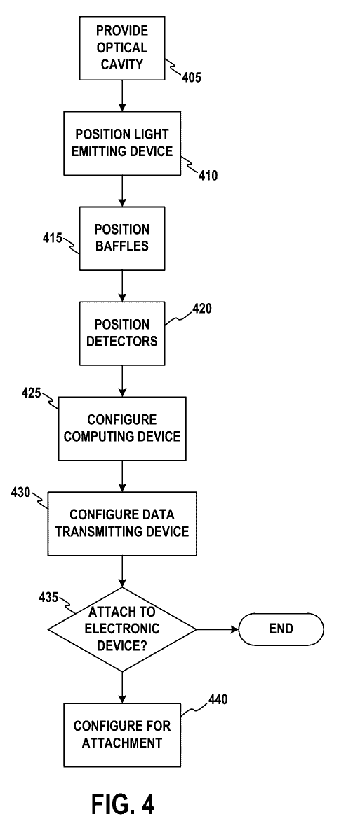

FIG. 4 depicts a flow diagram of an illustrative method of fabricating a particulate matter sensor according to an embodiment. In various embodiments, an optical cavity may be provided 405. The optical cavity may be a standalone optical cavity or may be integrated with or attached to various other components. For example, the optical cavity may be provided 405 as a portion of an optical bench. A light emitting device may be positioned 410 at or near the optical cavity, such adjacent to a first end of the optical cavity. The light emitting device may generally be positioned 410 such that it can emit electromagnetic radiation through the optical cavity, as described in greater detail herein. In particular embodiments, the light emitting device may be positioned 410 such that it directs a beam of light towards a second end of the optical cavity. In some embodiments, the light emitting device may be permanently affixed to the optical cavity. In other embodiments, the light emitting device may be removably affixed to the optical cavity. In some embodiments, the light emitting device may be in communication with a processor.

In various embodiments, at least one baffle may be positioned 415 at or near the optical cavity. The at least one baffle may generally be positioned 415 such that each baffle only directs electromagnetic energy that is scattered perpendicular to the direction of an incident beam in the optical cavity, as described herein. The at least one baffle may also be positioned 415 such that each baffle directs the electromagnetic energy from the optical cavity to at least one detector. Thus, the at least one baffle may be connected to the optical cavity and/or at least one detector.

In various embodiments, at least one detector may be positioned 420. Each detector may generally be positioned 420 such that it receives electromagnetic energy that is scattered perpendicular to the direction of an incident beam in the optical cavity, as described herein. In some embodiments, each detector may be positioned 420 such that the detector receives the scattered electromagnetic energy from the optical cavity via at least one baffle, as described herein. In some embodiments, each detector may be positioned 420 along a length of the optical cavity. In particular embodiments, each detector may be positioned 420 at or near an edge of a particulate matter detection device that is substantially parallel to the optical cavity, as described in greater detail herein.

In various embodiments, a computing device and a data transmitting device may be configured 425, 430. The computing device may generally be configured 425 to process and/or receive data from each detector that corresponds to an amount of measured scattered light, as described in greater detail herein. The data transmitting device may generally be configured 430 to communicate the data to a portable electronic device, as described in greater detail herein.

In various embodiments, a determination 435 may be made as to whether the particulate matter sensor is to be attached to at least a portion of an electronic device, such as a portable electronic device. If the particulate matter sensor is to be attached to an electronic device, the sensor may be configured 440 for attachment. Such a configuration 440 may include adding various adhesives, hook and loop mechanisms, clips, fasteners, tongue and groove mechanisms, and/or the like to provide the particulate matter sensor with a means for attachment to an electronic device. In some embodiments, the configuration 440 may be specifically designed such that the particulate matter sensor is attachable to a particular electronic device. In other embodiments, the configuration 440 may be designed such that the particulate matter sensor is attachable to a plurality of electronic devices or any electronic device.

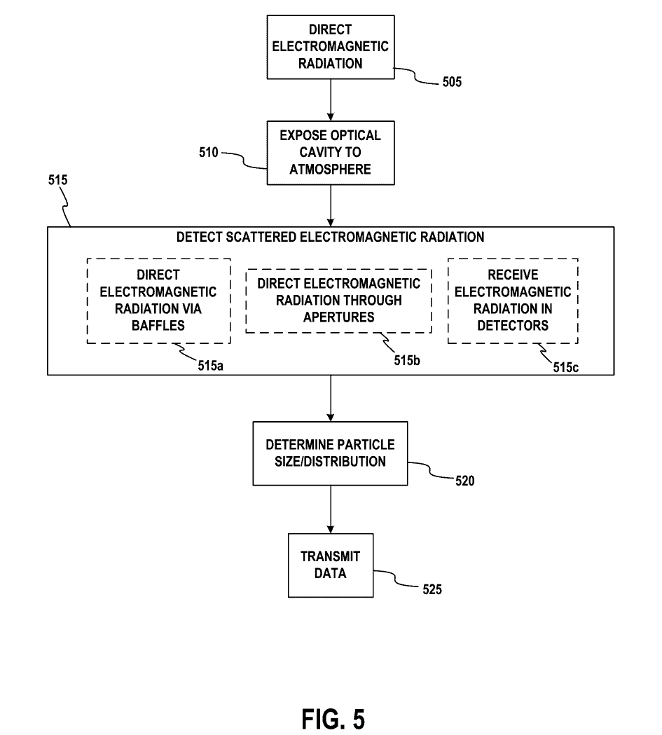

FIG. 5 depicts a flow diagram of a method of detecting particulate matter according to an embodiment. In some embodiments, a beam of electromagnetic radiation may be directed 505 through a cavity on a particulate matter sensor. The beam may generally be directed 505 from a first end of an optical cavity toward a second end of an optical cavity. In some embodiments, the beam may be continuously directed 505. In other embodiments, the beam may be directed 505 in pulses. In some embodiments, the beam may be directed 505 only during a sampling process. In some embodiments, the beam may be directed 505 in accordance with instructions from a processor.

In various embodiments, the optical cavity may be exposed 510 to an environment. In some embodiments, the environment may be an atmosphere where a user desires to obtain information regarding airborne particulate matter. Exposure 510 may allow the optical cavity to receive particles from the atmosphere. The particles may cause the electromagnetic radiation to scatter, as described in greater detail herein.

In various embodiments, the scattered electromagnetic radiation may be detected 515. In some embodiments, only portions of the electromagnetic radiation that have scattered substantially perpendicular to the direction in which the electromagnetic radiation was directed 505 may be detected 515. Such detection 515 may include, for example, directing 515a the scattered electromagnetic radiation via at least one baffle, as described in greater detail herein. In some embodiments, detection 515 may include directing 515b the scattered electromagnetic radiation through at least one aperture on a detector, as described in greater detail herein. In some embodiments, detection 515 may include receiving 515c the scattered electromagnetic radiation in at least one detector, as described in greater detail herein.

In various embodiments, a size and/or a distribution of particles that caused the electromagnetic radiation to scatter may be determined 520. Such a determination 520 may include measurement of DLS, as described in greater detail herein. In some embodiments, the determination 520 may be completed by a processor connected to the at least one detector, as described in greater detail herein.

In various embodiments, data obtained from the determination 520 may be transmitted 525. In some embodiments, the data may be transmitted 525 to an electronic device. As previously described herein, the data may be transmitted 525 via a wired or a wireless means for transmitting data.

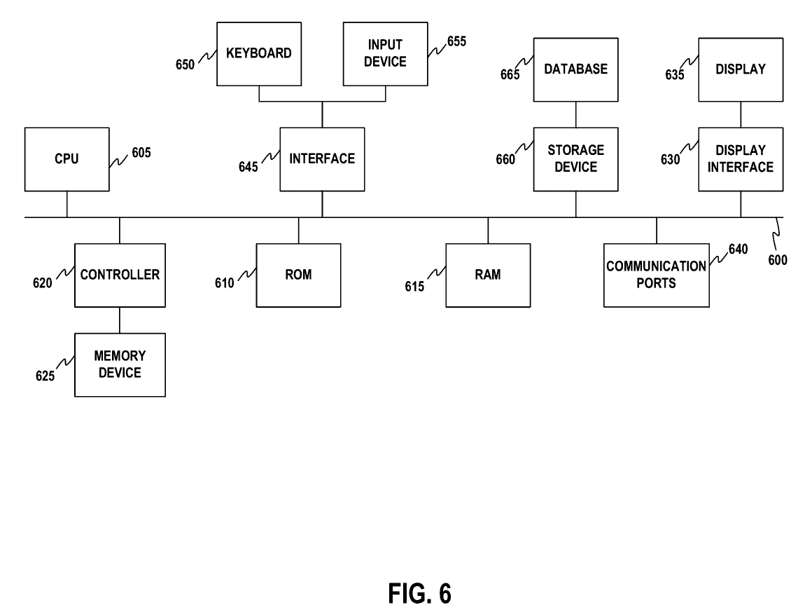

FIG. 6 depicts a block diagram of illustrative internal hardware that may be used to contain or implement program instructions, such as the process steps discussed herein, according to various embodiments. A bus 600 may serve as the main information highway interconnecting the other illustrated components of the hardware. A CPU 605 may be the central processing unit of the system, performing calculations and logic operations required to execute a program. The CPU 605, alone or in conjunction with one or more of the other elements disclosed in FIG. 6, is an illustrative processing device, computing device, or processor as such terms are used within this disclosure. Read only memory (ROM) 610 and random access memory (RAM) 615 constitute illustrative memory devices (i.e., processor-readable non-transitory storage media).

A controller 620 may interface with one or more optional memory devices 625 to the system bus 600. These memory devices 625 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 610 and/or the RAM 615. Optionally, the program instructions may be stored on a tangible computer-readable medium such as a compact disk, a digital disk, flash memory, a memory card, a USB drive, an optical disc storage medium, such as a Blu-Ray™ disc, and/or other non-transitory storage media.

An optional display interface 630 may permit information from the bus 600 to be displayed on the display 635 in audio, visual, graphic, or alphanumeric format, such as the interface previously described herein. Communication with external devices, such as an external electronic device as described herein, may occur using various communication ports 640. An illustrative communication port 640 may be the data transmitting device previously described herein, and may be attached to a communications network, such as the Internet, an intranet, or the like.

The hardware may also include an interface 645 which allows for receipt of data from input devices such as a keyboard 650 or other input device 655 such as a mouse, a joystick, a touch screen, a remote control, a pointing device, a video input device, an audio input device, and/or a detector, as previously described herein.

The hardware may also include a storage device 660 such as, for example, a connected storage device, a server, and an offsite remote storage device. Illustrative offsite remote storage devices may include hard disk drives, optical drives, tape drives, cloud storage drives, and/or the like. The storage device 660 may be configured to store data as described herein, which may optionally be stored on a database 665. The database 665 may be configured to store information in such a manner that it can be indexed and searched, as described herein.

The computing device of FIG. 6 and/or components thereof may be used to carry out the various processes as described herein.

### EXAMPLES

### Example 1

### Fabricating a Particulate Matter Sensor

An optical bench will be formed where the optical bench has dimensions that mirror those of an iPhone® 5S telephone (Apple, Inc., Cupertino Calif.). In addition, the optical bench will be 9 mm thick. The optical bench will have an integrated sleeve that allows the bench to be slidably attached to the back of the iPhone® 5S telephone without adding substantial size or bulk to the iPhone® telephone.

Forming the optical bench will include forming an optical cavity in a silicon substrate that runs along a length of the optical bench. The optical cavity will be substantially sealed, but can be opened at five closable inlets positioned along the length of the optical cavity. Such inlets will allow for the optical cavity to receive atmospheric samples.

A diode laser will be positioned at a first end of the optical cavity such that it directs a coherent monochromatic beam of light in a straight line towards a second end of the optical cavity. The optical bench will include a switch that a user can depress to turn the laser on and off during sensing. The switch will also be connected to other components.

Ten silicon avalanche photodetectors will be placed on the optical bench. Five of the detectors will be placed on a right side edge of the optical bench that is parallel to the optical cavity, and the remaining five detectors will be placed on a left side edge of the optical bench that is also parallel to the optical cavity. Each detector will be spaced at the same interval as the five inlets on the optical cavity such that particles received in the inlets will cause scattered light at 90 degree angles with respect to the direction of the light beam to pass directly through an aperture on a detector. In addition, baffles will be placed on the optical bench to ensure that only light that is scattered at 90 degrees with respect to the direction of the light beam reaches each detector.

A printed circuit board containing a processor and a Bluetooth® transmitting device will also be integrated with the optical bench. The processor will be connected via a bus to each of the detectors. Thus, when a detector measures scattered light, it transmits a signal to the processor, which is configured to generate data corresponding to the measured scattered light. The Bluetooth® transmitting device will then transmit the data to the iPhone® telephone, which has a companion application installed thereon for additional processing and transmission of the data.

### Example 2

### Detecting Particulate Matter

The optical bench of Example 1 will be attached to an iPhone® 5S telephone by sliding the iPhone® telephone into the sleeve such that the optical bench is held to the iPhone® telephone. To conduct a reading, a user will depress the switch on the optical bench, which will turn all of the components on and open the inlets so that air surrounding the optical bench is allowed to flow into the inlets.

The detectors will detect the portions of the laser beam that are scattered at the 90 degree angles with respect to the direction of the laser beam and directed via the baffles and the apertures. Information regarding the detected portions of the laser beam will be transmitted to the processor for processing into data according to the formulae described herein. The processor will direct the Bluetooth® transmitting device to send the data to the iPhone® telephone.

The companion application on the iPhone® telephone will direct the iPhone telephone to receive the data via Bluetooth® transmission and will upload the data to an air quality tracking database via an Internet connection. The Examples demonstrate that the particulate matter sensor according to the disclosed embodiments can measure air quality conditions and is sufficiently small and lightweight to be incorporated into portable electronic devices such as a smart phone. In addition, a large number of devices can be deployed within the consumer smart phone environment such that statistically relevant data may be collected over large geographic regions. Accordingly, various trends and movement in air content can be tracked and reported.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A particulate matter sensor comprising:
an optical cavity having a length;
a diode laser positioned at or near a first end of the optical cavity, wherein the diode laser is configured to direct a light beam in a direction towards a second end of the optical cavity;
a plurality of detectors positioned along the length of the optical cavity, wherein each of the plurality of detectors is configured to measure a portion of the light beam that is scattered substantially perpendicular to the direction;
a computing device that is configured to receive data from each of the plurality of detectors, wherein the data corresponds to an amount of measured scattered light; and
a data transmitting device configured to transmit the data to a portable electronic device.

2. The particulate matter sensor of claim 1, further comprising a plurality of baffles positioned along the length of the optical cavity, wherein each of the plurality of baffles is configured to direct the portion of the light beam that is scattered to one or more of the plurality of detectors.

3. The particulate matter sensor of claim 1, wherein each of the plurality of detectors comprises an aperture configured to direct the portion of the light beam that is scattered to a corresponding detector.

4. The particulate matter sensor of claim 1, wherein each of the plurality of detectors is further configured to measure one or more of a size and a distribution of particles that cause the portion of the light beam to scatter.

5. The particulate matter sensor of claim 1, wherein the optical cavity comprises a plurality of inlets configured to receive atmospheric samples in the optical cavity.

6. (canceled)

7. The particulate matter sensor of claim 1, wherein each of the plurality of detectors is a silicon avalanche photodetector.

8. The particulate matter sensor of claim 1, wherein the light beam is a coherent monochromatic light beam.

9. The particulate matter sensor of claim 1, wherein the particulate matter sensor is configured to attach to at least a portion of the portable electronic device.

10. The particulate matter sensor of claim 1, wherein the particulate matter sensor is a portion of the portable electronic device.

11. The particulate matter sensor of claim 1, wherein the portable electronic device includes one or more of a smartphone and a tablet computing device.

12. (canceled)

13. The particulate matter sensor of claim 1, wherein the particulate matter sensor is an optical bench.

14. The particulate matter sensor of claim 1, wherein the data transmitting device is further configured to transmit the data via at least one of a wired connection and a wireless connection.

15.-32. (canceled)

33. A method of fabricating a particulate matter sensor, the method comprising:
providing an optical cavity having a length;
positioning a diode laser at or near a first end of the optical cavity, wherein the diode laser is configured to direct a light beam in a direction towards a second end of the optical cavity;
positioning a plurality of detectors along the length of the optical cavity, wherein each of the plurality of detectors is configured to measure a portion of the light beam that is scattered substantially perpendicular to the direction;
configuring a computing device to receive data from each of the plurality of detectors, wherein the data corresponds to an amount of measured scattered light; and
configuring a data transmitting device to transmit the data to a portable electronic device.

34. The method of claim 33, further comprising positioning a plurality of baffles along the length of the optical cavity such that each of the plurality of baffles is configured to direct the portion of the light beam that is scattered perpendicular with respect to the direction to one or more of the plurality of detectors.

35. The method of claim 33, wherein positioning the plurality of detectors includes configuring an aperture of each of the plurality of detectors, to direct a portion of the light beam that is scattered at a right angle with respect to the direction to a corresponding detector.

36. The method of claim 33, wherein positioning the plurality of detectors comprises positioning a plurality of silicon avalanche photodetectors.

37. The method of claim 33, further comprising configuring the particulate matter sensor to attach to at least a portion of the portable electronic device.

38. A method of detecting particulate matter in atmospheric samples, the method comprising:
directing a beam of light in a direction through an optical cavity on a particulate matter sensor;
exposing the optical cavity to an atmosphere, wherein the optical cavity is configured to receive particles in the atmosphere, and the particles cause the beam of light to scatter;
detecting portions of the beam of light that have scattered substantially perpendicular to the direction;
determining a particle size and a particle distribution from the portions of the beam of light; and
transmitting data corresponding to the particle size and particle distribution to a portable electronic device.

39. The method of claim 38, wherein detecting comprises receiving, in one or more detectors, the portions of the beam of light that have scattered.

40. The method of claim 38, further comprising directing, by one or more apertures, the portions of the beam of light that have scattered to one or more detectors.

41. The method of claim 38, further comprising directing, by one or more baffles, the portions of the beam of light that have scattered to one or more detectors.

42. The method of claim 38, wherein transmitting the data comprises transmitting the data via one or more of a wired connection and a wireless connection.

43.-44. (canceled)
